(19) United States
(12) Patent Application Publication
(10) Pub. No.: US 2017/0169183 A1
(43) Pub. Date: Jun. 15, 2017

(54) QUANTITATIVE ASSESSMENT OF DRUG RECOMMENDATIONS

(71) Applicant: International Business Machines Corporation, Armonk, NY (US)

(72) Inventors: TAKAHIKO KOYAMA, Scarsdale, NY (US); KAHN RHRISSORRAKRAI, Woodside, NY (US); FILIPPO UTRO, White Plains, NY (US)

(21) Appl. No.: 14/968,140

(22) Filed: Dec. 14, 2015

(51) Int. Cl. G06F 19/00; C40B 30/02; G06F 19/12

(52) U.S. Cl. CPC G06F 19/3456; G06F 19/12; C40B 30/02

(57) ABSTRACT

Embodiments are directed to a computer implemented method of assessing a relevancy of a drug to a disease state of a patient. The method includes assessing an impact of the drug on driver genes (DGs) of the disease state of the patient, assessing an impact of the drug on druggable target genes (DTs) of the drug, and assessing the relationship between the DGs and DTs that are in one of a plurality of biological pathways of the disease state of the patient. The method further includes combining the impact of the drug on the DGs, the impact of the drug on the DTs, and the relationship between the DGs and DTs that are in the one of the biological pathways, wherein the combining results in an assessment of the relevancy of the drug to the disease state of the patient.

### BACKGROUND

The present disclosure relates in general to the identification and selection of appropriate drug therapies. More specifically, the present disclosure relates to systems and methodologies for improving the identification and selection of a drug therapy by making quantitative assessments of the relevance of candidate drug therapies to patient specific disease conditions.

Patients suffering from rapid-onset diseases such as some forms of cancer would benefit from clinicians having the ability to make a rapid evaluation of a given drug's potential therapeutic relevance to that patient's specific condition. There are, however, significant obstacles to efficiently and effectively creating a personalized drug regimen for treatment of a particular patient's disease state. Specifically, the relevancy of a given drug to a given disease depends on possibly hundreds or thousands of interrelated variables. For example, because biological pathways are the basic mechanism for genes to communicate and/or interact with one another, a drug's relevancy to particular patient disease state may be influenced by all possible pathways that participate in the emergence of the disease state, as well as how these possible pathways are altered by changes in gene activity of any member of the pathway.

It would be beneficial to provide systems and methodologies to allow clinicians to effectively and efficiently filter and/or sort the hundreds or thousands of potential drugs available to treat a particular disease in a specific patient to create a highly personalized drug treatment regiment, which may in some cases include drugs that are not be generally known to be part of the diagnostic and treatment process for a certain type of patient, illness or clinical circumstance.

### SUMMARY

Embodiments are directed to a computer implemented method of assessing a relevancy of a drug to a disease state of a patient. The method includes assessing an impact of the drug on driver genes (DGs) of the disease state of the patient, assessing an impact of the drug on druggable target genes (DTs) of the drug, and assessing the relationship between the DGs and DTs that are in one of a plurality of biological pathways of the disease state of the patient. The method further includes combining the impact of the drug on the DGs, the impact of the drug on the DTs, and the relationship between the DGs and DTs that are in the one of the biological pathways, wherein the combining results in an assessment of the relevancy of the drug to the disease state of the patient.

Embodiments are further directed to a computer system for assessing a relevancy of a drug to a disease state of a patient. The system includes a memory and a processor system communicatively coupled to the memory. The processor system configured to perform a method including assessing an impact of the drug on DGs of the disease state of the patient, assessing an impact of the drug on druggable target genes DTs of the drug, and assessing the relationship between the DGs and DTs that are in one of a plurality of biological pathways of the disease state of the patient. The method further including combining the impact of the drug on the DGs, the impact of the drug on the DTs, and the relationship between the DGs and DTs that are in the one of the biological pathway, wherein the combining results in an assessment of the relevancy of the drug to the disease state of the patient.

Embodiments are further directed to a computer program product for assessing a relevancy of a drug to a disease state of a patient. The computer program product includes a computer readable storage medium having program instructions embodied therewith, wherein the computer readable storage medium is not a transitory signal per se, and the program instructions are readable by a processor system to cause the processor system to perform a method. The method includes assessing an impact of the drug on DGs of the disease state of the patient, assessing an impact of the drug on DTs of the drug, and assessing the relationship between the DGs and DTs that are in one of a plurality of biological pathways of the disease state of the patient. The method further includes combining the impact of the drug on the DGs, the impact of the drug on the DTs, and the relationship between the DGs and DTs that are in the one of the biological pathways, wherein the combining results in an assessment of the relevancy of the drug to the disease state of the patient.

Additional features and advantages are realized through the techniques described herein. Other embodiments and aspects are described in detail herein. For a better understanding, refer to the description and to the drawings.

### BRIEF DESCRIPTION OF THE DRAWINGS

The subject matter which is regarded as the present disclosure is particularly pointed out and distinctly claimed in the claims at the conclusion of the specification. The foregoing and other features and advantages are apparent from the following detailed description taken in conjunction with the accompanying drawings in which:

FIG. 1 depicts an exemplary computer system capable of implementing one or more embodiments of the present disclosure;

FIG. 2 depicts a diagram of an exemplary system in accordance with one or more embodiments;

FIG. 3A depicts equations that may be implemented by modules of the system shown in FIG. 2 in accordance with one or more embodiments;

FIG. 3B depicts additional equations that may be implemented by modules of the system shown in FIG. 2 in accordance with one or more embodiments;

FIG. 3C depicts additional equations that may be implemented by modules of the system shown in FIG. 2 in accordance with one or more embodiments;

FIG. 4 depicts a flow diagram illustrating a methodology in accordance with one or more embodiments;

FIG. 5 depicts a table illustrating exemplary pathway assessment results in accordance with one or more embodiments;

FIG. 6 depicts diagrams illustrating examples of how drug pathway scores of the system shown in FIG. 2 may be implemented in accordance with one or more embodiments;

FIG. 7 depicts a histogram of drug scores with fitted binomial distribution for a neuroblastoma patient sample in accordance with one or more embodiments; and

FIG. 8 depicts a computer program product in accordance with one or more embodiments.

In the accompanying figures and following detailed description of the disclosed embodiments, the various elements illustrated in the figures are provided with three or four digit reference numbers. The leftmost digit(s) of each reference number corresponds to the figure in which its element is first illustrated.

### DETAILED DESCRIPTION

Various embodiments of the present disclosure will now be described with reference to the related drawings. Alternate embodiments may be devised without departing from the scope of this disclosure. It is noted that various connections are set forth between elements in the following description and in the drawings. These connections, unless specified otherwise, may be direct or indirect, and the present disclosure is not intended to be limiting in this respect. Accordingly, a coupling of entities may refer to either a direct or an indirect connection.

The present disclosure provide systems and methodologies for improving the identification and selection of a drug therapy by making quantitative assessments of the relevance of candidate drug therapies to patient specific disease conditions. The present disclosure combines information from both literature (community consensus information) and an in-depth analysis of a patient's genomic profile. Specifically, from the genomic profile analysis, the present disclosure scores a drug's potential efficacy based on an analysis of its molecular target's relationship to genes promoting patient disease. The resulting score thereby reflects patient specific conditions and community consensus information to enable the ranking and filtering of potential drug therapies

A component of the disclosed methodology for measuring drug relevancy with respect to a disease is an evaluation of the biological relationship between the drug's targets (DTs) and a set of genes referred to herein as druggable genes or driver genes (DGs). DGs are defined as genes that are causally linked to the formation and development of a disease. In general, for purposes of the present disclosure, the term DG is used to refer to a gene that advances (or drives) a biological pathway that is involved in some kind of disease. There are many DGs that drive many pathways that can result in a given disease. Biological relationships are based on biological interactions that lead from a DG to a DT in the context of known biological pathways. Typically, these genes and their products are behaving aberrantly. Some example sources of these aberrations include, but not limited to, gene mutations (a change in DNA sequence that makes up a gene) and over or under expression of the gene as detected by RNA expression or copy number variation. Thus, in the present disclosure the determination that a given drug is relevant to the treatment of a selected disease is based at least in part on the identification of the DGs in a biological pathway that advance the pathway toward the selected disease state, as well as the relationship of the drug to actionable DTs also present in the pathway.

As background, a general description of biological pathways will now be provided. A biological pathway is a series of actions among molecules in a cell that leads to a certain product or a change in a cell. Such pathways can trigger the assembly of new molecules, such as a fat or a protein. Pathways can also turn genes on and off, or spur a cell to move. Thus, pathways constantly transport signals or cues to cells from both inside and outside the body, which are prompted by such things as injury, infection, stress or even food. To react and adjust to these cues, cells also send signals and cues through biological pathways. The molecules that make up biological pathways interact with signals, as well as with each other, to carry out their designated tasks. Biological pathways can act over short or long distances. For example, some cells send out signals to nearby cells to repair localized damage, such as a scratch on your knee. Other cells produce substances, such as hormones, that travel through your blood to distant target cells. Biological pathways can also produce small or large outcomes. For example, some pathways subtly affect how the body processes drugs, while others play a major role in how a fertilized egg develops into a baby.

There are many types of biological pathways. Some of the most common are involved in metabolism, the regulation of genes and the transmission of signals. Metabolic pathways make possible the chemical reactions that occur in our bodies. An example of a metabolic pathway is the process by which human cells break down food into energy molecules that can be stored for later use. Other metabolic pathways actually help to build molecules. Gene regulation pathways turn genes on and off. Such action is vital because genes produce proteins, which are the key component needed to carry out nearly every task in our bodies. Proteins make up our muscles and organs, and help our bodies move and defend us against germs. Signal transduction pathways move a signal from a cell's exterior to its interior. Different cells are able to receive specific signals through structures on their surface, called receptors. After interacting with a receptor, the signal travels through the cell where its message is transmitted by specialized proteins that trigger a specific action in the cell. For example, a chemical signal from outside the cell might be turned into a protein signal inside the cell. In turn, that protein signal may be converted into a signal that prompts the cell to move.

Biological pathways do not always work properly. When something goes wrong in a pathway, the result can be a disease such as cancer or diabetes. Researchers often learn about human disease from studying biological pathways. Identifying what genes, proteins and other molecules are involved in a biological pathway can provide clues about what goes wrong when a disease strikes. For example, researchers may compare certain biological pathways in a healthy person to the same pathways in a person with a disease to assist in discovering the roots of the disorder.

The identification of relevant pathways from a set of genes is often the first step in implementing this research philosophy. However, determining the pathways that are most relevant for a set of diseased genes is challenging, and is often made even more difficult by differences in pathway composition and topology that are present between different pathway repositories. For example, problems in any number of steps along a biological pathway can often lead to the same disease. Genetic mutations also complicate the identification of relevant pathways for disease state. For example, cancer is a genomic disease associated with a plethora of gene mutations. Among these mutated genes, driver genes are defined as being causally linked to the formation and development of tumors, while passenger genes are thought to be irrelevant for cancer development. Different genetic mutations can lead to the same cancer in different patients. Instead of attempting to discover ways to attack one well-defined genetic enemy, this complex view can be simplified by identifying and focusing on the biological pathways that are disrupted by the genetic mutations. Rather than designing dozens of drugs to target dozens of mutations, drug developers could focus their attentions on just two or three biological pathways. Patients could then receive the one or two drugs most likely to work for them based on the pathways affected in their particular tumors.

The accurate identification of pathways that are involved in a disease, and of the steps of the identified pathways that are affected in each patient, may lead to more personalized strategies for diagnosing, treating and preventing disease. Researchers currently are using information about biological pathways to develop new and better drugs. Additionally, pathway information may also be used to more effectively choose and combine existing drugs. With increasing numbers of large scale genomic datasets available, integrating these genomic data to identify driver genes from aberration regions of cancer genomes becomes an important goal of cancer genome analysis and investigations into mechanisms responsible for cancer development.

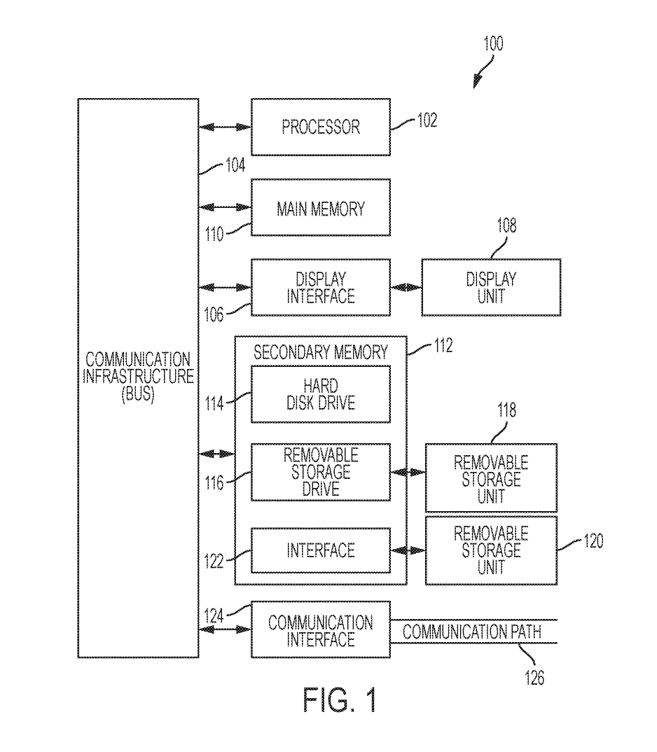

Turning now to the drawings in greater detail, wherein like reference numerals indicate like elements, FIG. 1 illustrates a high level block diagram showing an example of a computer-based information processing system 100 useful for implementing one or more embodiments of the present disclosure. Although one exemplary computer system 100 is shown, computer system 100 includes a communication path 126, which connects computer system 100 to additional systems (not depicted) and may include one or more wide area networks (WANs) and/or local area networks (LANs) such as the Internet, intranet(s), and/or wireless communication network(s). Computer system 100 and additional system are in communication via communication path 126, e.g., to communicate data between them.

Computer system 100 includes one or more processors, such as processor 102. Processor 102 is connected to a communication infrastructure 104 (e.g., a communications bus, cross-over bar, or network). Computer system 100 can include a display interface 106 that forwards graphics, text, and other data from communication infrastructure 104 (or from a frame buffer not shown) for display on a display unit 108. Computer system 100 also includes a main memory 110, preferably random access memory (RAM), and may also include a secondary memory 112. Secondary memory 112 may include, for example, a hard disk drive 114 and/or a removable storage drive 116, representing, for example, a floppy disk drive, a magnetic tape drive, or an optical disk drive. Removable storage drive 116 reads from and/or writes to a removable storage unit 118 in a manner well known to those having ordinary skill in the art. Removable storage unit 118 represents, for example, a floppy disk, a compact disc, a magnetic tape, or an optical disk, etc. which is read by and written to by removable storage drive 116. As will be appreciated, removable storage unit 118 includes a computer readable medium having stored therein computer software and/or data.

In alternative embodiments, secondary memory 112 may include other similar means for allowing computer programs or other instructions to be loaded into the computer system. Such means may include, for example, a removable storage unit 120 and an interface 122. Examples of such means may include a program package and package interface (such as that found in video game devices), a removable memory chip (such as an EPROM, or PROM) and associated socket, and other removable storage units 120 and interfaces 122 which allow software and data to be transferred from the removable storage unit 120 to computer system 100.

Computer system 100 may also include a communications interface 124. Communications interface 124 allows software and data to be transferred between the computer system and external devices. Examples of communications interface 124 may include a modem, a network interface (such as an Ethernet card), a communications port, or a PCM-CIA slot and card, etcetera. Software and data transferred via communications interface 124 are in the form of signals which may be, for example, electronic, electromagnetic, optical, or other signals capable of being received by communications interface 124. These signals are provided to communications interface 124 via communication path (i.e., channel) 126. Communication path 126 carries signals and may be implemented using wire or cable, fiber optics, a phone line, a cellular phone link, an RF link, and/or other communications channels.

In the present disclosure, the terms “computer program medium,” “computer usable medium,” and “computer readable medium” are used to generally refer to media such as main memory 110 and secondary memory 112, removable storage drive 116, and a hard disk installed in hard disk drive 114. Computer programs (also called computer control logic) are stored in main memory 110 and/or secondary memory 112. Computer programs may also be received via communications interface 124. Such computer programs, when run, enable the computer system to perform the features of the present disclosure as discussed herein. In particular, the computer programs, when run, enable processor 102 to perform the features of the computer system. Accordingly, such computer programs represent controllers of the computer system.

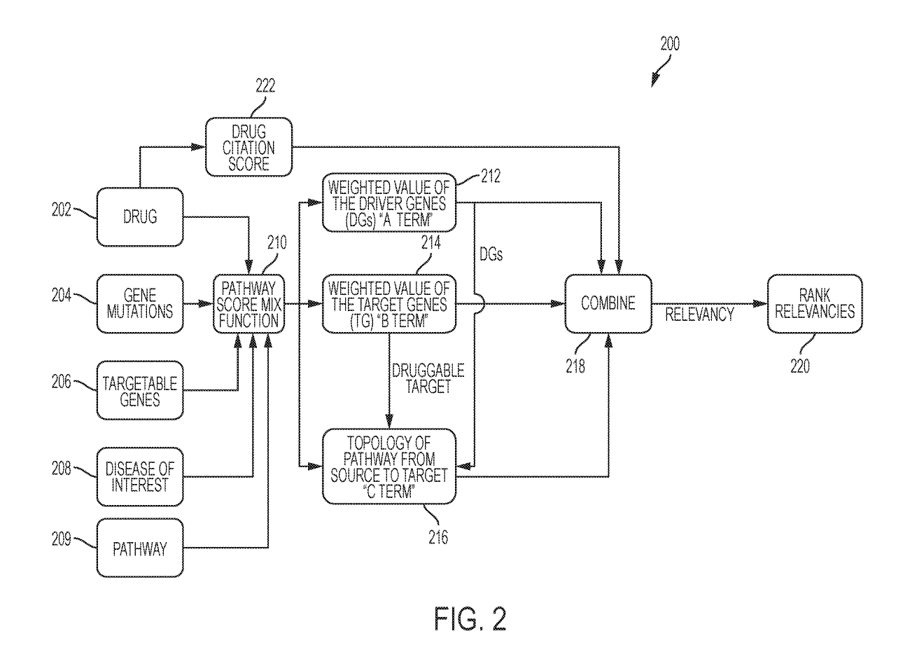

FIG. 2 depicts a diagram of a drug assessment system 200 in accordance with one or more embodiments. The various functional modules of drug assessment system 200 may be implemented using computer-based information processing system 100 shown in FIG. 1. As shown in FIG. 2, drug assessment system 200 includes drug of interest inputs 202, gene mutations (GMs) inputs 204, targetable genes inputs 206, disease of interest inputs 208, pathway inputs 209, a pathway score mix function 210, a weighted value of driver genes (DGs) module 212, a weighted value of target gene (TG) module 214, a topology of the pathway from source to target module 216, a drub citation score module 218, a combine module 220 and a rank relevancies module 222, configured and arranged as shown.

In its overall operation, drug assessment system 200 ranks the relevance of a drug to a particular patient disease condition based on a quantitative determination of the likelihood that the drug can impact the development of the particular patient disease condition. The determination that a given drug is involved in the development of or relevant to the treatment of, a particular patient disease condition is based at least in part on the identification of genes in the pathway that advance the pathway toward the patient's disease state.

A GM is a change in DNA sequence that makes up a gene. GMs complicate the identification of relevant pathways for disease state. For example, cancer is a genomic disease associated with a plethora of GMs. Among these GMs, DGs are defined as the GMs that are causally linked to the formation and development of tumors, while passenger genes are GMs thought to be irrelevant for cancer development. Different DGs can lead to the same cancer in different patients. In general, for purposes of the present disclosure, the term DG is used to refer to a GM that advances (or drives) a pathway that is involved in some kind of disease. There are many DGs that drive many pathways that can result in a given disease. For a given disease, there are typically a certain number of DGs (e.g., 15 to 20) that are most significant.

As shown in FIG. 2, the initial data inputs to system 200 are a selected drug database (drug inputs 202), a selected pool of GMs for a given disease of interest (GMs inputs 204), the druggable target genes (TGs) associated with the disease of interest (targetable genes inputs 206), a disease of interest (disease of interest inputs 208) and a selected pathway database (pathway inputs 209). The pathway database may be selected based on a number of factors. In the present disclosure, one or more embodiments consider a cancer-specific, hand curated pathway database known as NCI-PID. Other considerations in selecting a suitable pathway database include but are not limited to: the level of curation (e.g., manual vs. NLP); cancer and/or other disease-specific biological pathways; the degree of experimental support for the pathway; high throughput vs. low throughput data sources; the desire for human, mammalian other animal and plant data sources; orthology based links; and the type of interactions desired (e.g., physical, logical, correlative, etc.).

A disease of interest is selected based on the needs and interests of the individual user. Once a disease of interest (disease of interest input 208) is identified, the most significant genes and gene mutations (GMs inputs 204) involved in the selected disease can then be identified. In general, GMs inputs 204 may be compiled from existing literature or databases. Additionally, known computational and informatics methods for inferring the most significant GMs may also be utilized. The method for determining the pool of GMs is dependent on the application, e.g. a clinical treatment or a basic research application.

Once a disease of interest (disease of interest input 208) is identified, the druggable target genes (targetable genes 206) associated with the disease of interest can also be identified from drug information databases (drug database 202). For example, druggable target genes may be compiled from existing literature or databases. Computational and informatics methods may also be used to infer druggable targets. The particular method chosen for determining a pool of druggable target genes is dependent on the application, e.g. a clinical treatment or a basic research application.

Drug database 202 is also used by drug citation score module 222 to determine if the relevant drugs identified through drug database 202 have applications broader than the specific diseases the drugs have been approved to treat. For example, a drug that has been approved for heart disease or colon cancer may also have been demonstrated to have efficacy for breast or liver cancer. In one or more embodiments, drug citation score 222 looks at the literature and determines whether a particular drug has been studied in the context of a particular patient's disease (i.e., patient specific disease context). In effect, a citation score may be developed by searching medical literature for the co-occurrence of the mention of a drug name with either a broad term like cancer treatment or a more specific term for a particular form of cancer relevant to a particular patient. Module 218 combines the outputs of the assessments made by modules 222, 212, 214 and 216 and determines a relevancy of each drug of interest as described in greater detail later in this disclosure.

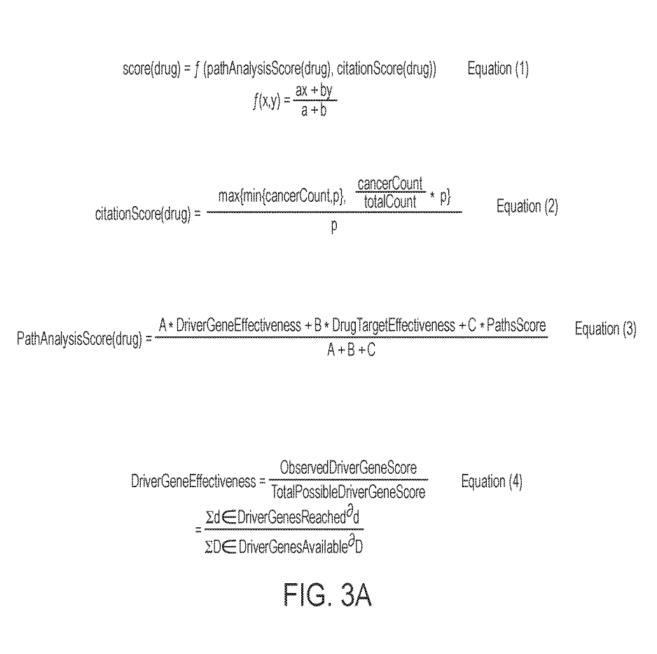

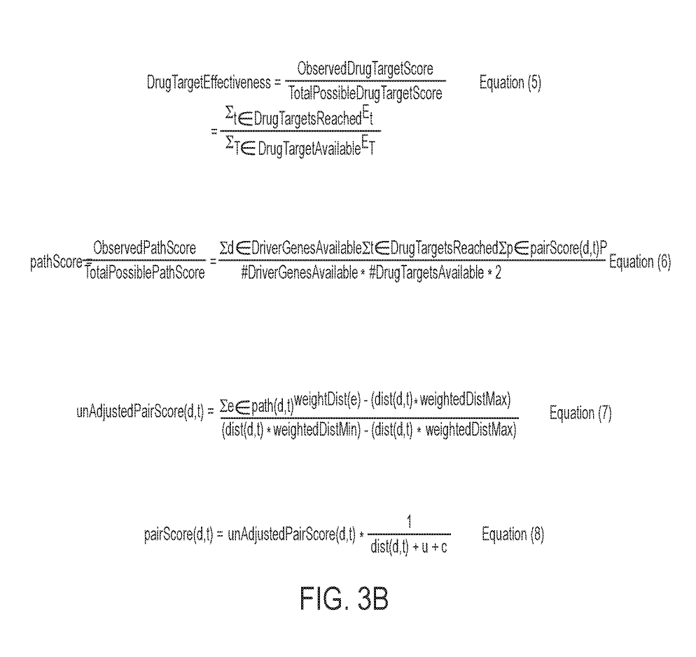

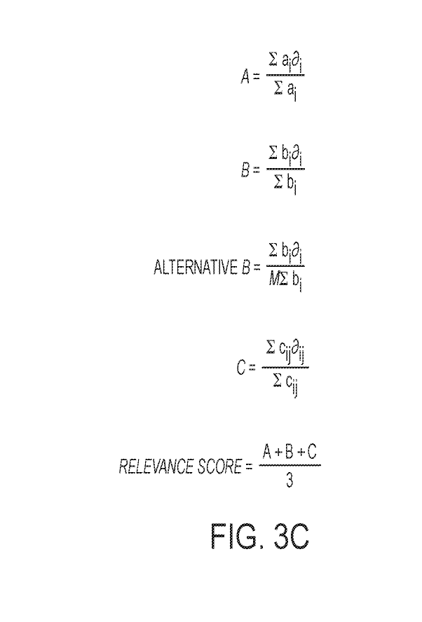

A pathway score mix function module 210 receives inputs from drug database inputs 202, GMs inputs 204, targetable genes inputs 206, disease of interest inputs 208 and pathway inputs 209, and selectively provides them to modules 212, 214 and 216 according to a general multiplex functionality. Module 312 calculates a weighted value of the DGs. In one or more embodiments, module 312 calculates the weighted value of the DGs according to an A-term, shown at Equation (3) in FIG. 3A, and shown in greater detail in FIG. 3C. In the A-term, aᵢ is a number that weights the presence of each of the “i” GMs. Thus, “a” can take into account cnv (copy number variations), number of DGs, etcetera. Thus, “a” identifies the GMs that are more meaningful than others. The value of “a” can be derived from external knowledge, for example the level of activity of the GM and its presumed importance in the pathway of interest. There is considerable flexibility on the selection of “a”. For example, “a” could be implemented as a Bayesian model, support vector machine, and the like. The flexibility in the selection of “a” allows it to be changed over time as the input data to system 200 improves and changes over time.

Continuing with the A-term shown in FIG. 3C, ∂ᵢ is a binary term that is zero (0) if the GM cannot be affected by the drug of interest, and is a one (1) if the GM can be affected by the drug of interest. In other words, ∂ᵢ is a one (1) if the GM is a targetable DG for the current pathway of interest, and ∂ᵢ is a zero (0) if the GM is not a targetable DG for the pathway of interest. It is noted that at this stage of the process, the A-term and subsequent PathAnalysisScore (Equation (3) shown in FIG. 3C) are determined for a specific drug in isolation of any other drug, but will be subsequently used to compare the relevancies between drugs. Thus, the binary term ∂ᵢ has the effect of eliminating from the numerator of the A-term any GM that is not targetable by the drug of interest that leads to a particular disease of interest. It is noted that system 200 and its associated methodologies evaluate a set of GMs that are initially thought to be relevant for a given patient in the context of the particular disease of interest. Accordingly, all of the GMs are evaluated against a set of predefined pathways. Thus, there will be some pathways that do not contain any of the patient-specific GMs. The source of ∂ᵢ is a search of the current pathway of interest to find a drug relevant to a DG. Thus, whether the GM is present or not will determine whether ∂_{I} is a one (1) or a zero (0), respectively.

Accordingly, the A-term provides a representation of the relevancy of a current drug of interest versus all other drugs considered. If the “a” values for all drugs of interest are equal, then the A-term will represent the sensitivity of that drug to capturing the set of GMs. When the “a” values for all drugs of interest are not equally weighted, then the A-term will represent the relevancy with respect to the considerations that support the calculation of “a.” In other words, the A-term represents the percentage of the initial GM pool that are DGs, and therefore most likely to advance a pathway that results in a particular disease of interest. The higher the A-term, the greater impact the drug is expected to have on the identified DGs in the pathway.

Module 214 calculates a weighted value of the TG. In one or more embodiments, module 314 calculates the weighted value of the TG according to a B-term, shown at Equation (3) in FIG. 3A, and shown in greater detail in FIG. 3C. The B-term is similar in structure to the A-term. While the A-term focuses on an identification and assessment of the DGs, the B-term focuses on an identification and assessment of the TG. Thus, the B-term also takes into account the DGs identified as part of the A-term calculation. In the B-term, for all drug targets from 1 to “i,” bᵢ is a number that weights the considerations associated with targeting the “i” druggable gene (DG), for example the centrality of the gene in a signaling network. The value of bᵢ can include items such as the nature and efficacy of the specific drug(s) targeting the gene or the level of activity of a gene “i.” Continuing with the B-term, ∂ᵢ is a binary term that is zero (0) if the druggable gene “i” is not upstream and/or downstream of any mutated genes (e.g., DGs) in the current pathway of interest, and ∂ᵢ assumes the value one (1) if the druggable gene “i” is upstream and/or downstream of any mutated genes (e.g., DGs) in the current pathway of interest.

Alternatively, the B-term may also be given by an alternative B-term equation shown in FIG. 3C, wherein M is provided in the numerator as shown. M may be defined as the number of druggable gene targets across a set of pathways. M functions as a normalization term, which ensures that the alternative B-term is a real value between zero (0) and one (1). In the alternative B-term calculation, in addition to a weighting of targeting gene “i,” the value of bᵢ may also be modified to account for the potential effects of mutations present upstream and downstream of gene “i” on drugs targeting “i,” for example by taking the ratio of mutations upstream of “i” to all mutations upstream and downstream of “i.”

Accordingly, the B-term provides a representation of a relevancy of a current drug of interest versus all other drugs considered. If the “b” values for all drugs of interest are equal, then the B-term merely represents the sensitivity of that drug to capturing the set of druggable target genes. When the “b” values for all drugs of interest are not equally weighted, then the B-term represents the relevancy with respect to the considerations that support the calculation of “b.”

Module 216 calculates a topology of the pathway from source to target. In one or more embodiments, module 216 calculates the topology of the pathway from source to target according to a C-term, shown at Equation (3) in FIG. 3A, and shown in greater detail in FIG. 3C. The C-term is similar in structure to the A-term and the B-term. While the A-term focused on an identification and assessment of the DGs, and the B-term focuses on an identification and assessment of the TGs, the C-term focuses on the relationship between the A-term and the B-term, and also takes into account both the DGs identified by the A-term and the druggable target identified by the B-term. In the C-term, for all DGs from 1 to “i,” and for all druggable targets from one (1) to “j,” ∂ᵢⱼ assumes the value one (1) if either the druggable gene “i” is downstream of the mutated gene “j” (i.e., DG) in the pathway or if “i” is a druggable gene and equal to “j.” Otherwise, ∂ᵢⱼ assumes the value of zero (0). Continuing with the C-term, “d” is the number of druggable target(s) present in the current pathway of interest with pathways to a DG and “n” is the number of DGs in the current pathway of interest. Finally in the C-term, cᵢⱼ is a real number that weights the relationship between individual DG “i” and individual TG “j.” For instance, the value of cᵢⱼ can be based on the distance (i.e., number of protein/small molecule) and/or directionality between the individual DG “i” and the individual TG “j,” or the value of cᵢⱼ can be based on the frequency at which the individual DG “i” is in a path to any DG.

Thus, in modules 212, 214, 216 of drug assessment system 200, the A-term, the B-term and the alternative B-term bring into the pathway assessment portion of system 200 a weighting factor that allows a quantification of the importance of a DG or druggable target gene. In addition, the C-term bring into the pathway assessment portion of system 200 a way to take into consideration the actual topology of the current pathway of interest. In other words, the C-term allows a consideration of the connections from the source gene (e.g., GM) to the druggable target. Thus, the weighting applied by the A and B terms is dictated by whether or not there is a path between the DG and target, as well as by the distance of the path between the DG and target. The topology can be further accounted for by including additional information regarding the expression of each gene along that path. In this way, instead of following the path's route along a flat surface (e.g., in a “no gene expression” scenario), the route along a contoured surface may be traced, wherein the contour heights are dictated by the expression level. A score may then be determined to minimize the total distance that accounts for those contours. Additionally, the topology can be accounted for by evaluating the number and variety of possible routes between the DG and the target.

Module 218 combines the outputs of the assessments made by modules 222, 212, 214 and 216 and determines a relevancy of each drug of interest. In one or more embodiments, the relevancy of the current pathway of interest may be implemented as a computed drug assessment/effectiveness score, shown at Equation (1) in FIG. 3A, that represents the relevancy of a drug of interest. Module 220 assembles and ranks the relevancies serially computed by module 218. The overall development of the drug relevancy score of Equation (1) with now be described with reference to the equations shown in FIGS. 3A and 3B.

The overall drug assessment/effectiveness measure shown in Equation (1) considers two primary features, namely the drug effectiveness as determined by disease-related citations and the drug effectiveness determined by pathway analysis. These two features are each given a quantitative score and combined into a single measure. In Equation (1), a and b are numbers [0-1] that weight the relative importance of the pathway analysis score and citation score, respectively. These weights can be learned through testing with a set of known recommended drugs for a particular patient sample and maximizing drug scores for therapeutically effective drugs. Both the pathAnalysisScore and citationScore of Equation (1) are values between 0 and 1, and are described greater detail below. Equation (1) enables the rapid sorting and potential filtering of drugs to more efficiently review potential therapeutic agents in a patient specific manner. Drug filtering is an important feature of the present disclosure as the space of potentially effective drugs can be large. This filtering can be accomplished by determining a threshold by which to remove low scoring drugs. There are several ways to compute this threshold, including machine learning, a feedback system, fitting distributions, etc. In an example provided later in this disclosure, an example of such a threshold is provided, wherein the threshold is determined by the simple fitting of multiple distributions.

An example citationScore in the context of an application to cancer is shown at Equation (2) of FIG. 3A. Principally, the citationScore may be implemented as any function that evaluates the effectiveness or prominence of a particular drug of the treatment or application to a disease. The citationScore can be calculated using a number of methods, e.g., support-vector machines, neural networks, Bayesian models, natural language processing, etc. For the exemplary citationScore implementation shown in Equation (2), the citationScore in the context of cancer can be, but is not limited to, the maximum of either the number of citations that reference the drug with phrases such as “cancer treatment,” the cancerCount or the ratio of the cancerCount to the number of citations that mention the drug, i.e., the totalCount. The cancerCount score is provided to avoid penalizing drugs that are in widespread use for many purposes other than cancer but may still be strongly efficacious to cancer treatment. This score may optionally be provided with a maximum value if it is determined that a point of diminished return in the context of the present disclosure is likely to be reached with more than a predetermined number of papers relating a drug to a condition. The function of the cancerCount/totalCount component is to upweight drugs that have been primarily studied in a cancer context, even if there are fewer overall publications.

Equation (3) depicts an example implementation of the PathAnalysisScore, A more detailed example of how the PathAnalysisScore may be implemented is described earlier herein in connection with the description of modules 212, 214 and 216 of FIG. 2, and the equations shown in FIG. 3B. The PathAnalysisScore is based on a traversal of biological pathways to identify relationships (or paths) between DGs and DTs. A variety of methodologies may be used to traverse the biological pathways, including, for example, identifying the shortest path by number of edges, or links, between the DG and DT. The PathAnalysisScore considers three factors: the coverage and importance of the driver genes reached (DriverGeneEffectiveness); the coverage and importance of the drug target genes reached (DrugTargetEffectiveness); and the overall quality of paths found between DG and DT (PathsScore). These factors are combined the following formulation shown in FIG. 3, wherein A, B, and C are real value numbers [0-1] that weight the relative importance of each of their respective factors. These weights can be learned through testing with a set of gold standard recommended drugs for a particular patient sample and maximizing drug scores for therapeutically effective drugs. Each of the three terms in Equation (3) (i.e., DriverGeneEffectiveness, DrugTargetEffectiveness and PathsScore) is described in greater detail below.

The DriverGeneEffectivess score considers the space of all DGs provided to as an input to system 200 (shown in FIG. 2) and present in any of the biological pathways analyzed by system 200. The DriverGeneEffectivenes develops a total possible score if a drug's targets were able to reach all available DGs via a pathway traversal, and then calculates an observed score. The methodology of the present disclosure may accept DGs with or without an associated score of the DGs relative importance. Equation (4) depicts an example implementation of the DriverGeneEffectiveness calculation, wherein ∂ᵢ is the associated score for the DG. If there is no score, then ∂ᵢ is 1.

The DrugTargetEffectiveness score considers the space of all of a drug's known targets that are present in any biological pathway analyzed. The DrugTargetEffectiveness score develops a total possible score if DGs were able to reach all the available drug targets in all pathways. The DrugTargetEffectiveness score then calculates the observed score. The drug targets can be weighted by a number of factors, including the drug efficacy with respect to that target or target gene activity. In the most basic formulation, gene activity level will be used when the data is available. If unavailable, then the activity level will be 1. An example implementation of the DrugTargetEffectiveness score is shown at Equation (5) in FIG. 3B, wherein E is the activity level of the drug target.

The PathsScore considers all found paths between the DGs and the DTs that are available in the pathways. The PathsScore calculates the total possible score if there were a path in both directions between all DGs and DTs. The PathsScore then totals the observed value. Each path, or DG-DT pair, is scored as a value (i.e., from 0 to 1), which is described herein as a pairScore. An example implementation of the PathsScore is shown at Equation (6) in FIG. 3B.

A more detailed example of the pairScore(d,t) of Equation (6) is shown by the unAdjustedPairScore of Equation (7). The pairScore(d,t) is an adjusted score for the weighted path between the driver d and drug target t. The unadjusted pairScore is the total weighted distance along the length of the path, which is scaled from 0 to 1. This score represents an overall strength into the path. Equation (7) shows an example implementation of the unAdjustedPairScore(d,t), wherein e is edge, or interaction, along the path between d and t. The weightedDist(e) is the weighted distance of the edge, which is provided to system 200 as an input. An example of this weighted distance can be the average expression of the genes that the edge directly connects, or a discrete categorization based on expression and edge interaction type. By using gene expression as the weight on the path, a shortest distance method would inherently account for the effects of changes in gene activity on the path's effectiveness. The weightedDistMax and the weightedDistMin are the maximum and minimum, respectively, weighted distance values possible. The dist(d,t) is the unweighted distance between d and t, and at its most basic iteration is the number of edges in the path.

To better distinguish categories of pairs, the scores are adjusted according to three rules. First, if t is downstream of d, pairs are weighted by the distance, i.e. number of links, between d and t. Here shorter paths are given higher scores. Second, if it is upstream of d, pairs are weighted as above but with an additional weight u that is equal to or greater than the maximum downstream distance. This ensures that upstream pairs are always scored lower than downstream pairs. Third, if t is a complex with d, pairs are weighted as above but with an additional weight c that is equal to or greater than the maximum upstream distance. This ensures the complex pairs are always scored lower than the upstream pairs. Accordingly, an example implementation of the pairScore(d,t) is shown at Equation (8), wherein: u is ≧maximum downstream distance if t is upstream of d and 0 otherwise; c is ≧the sum of the maximum downstream distance and the maximum upstream distance if d and t are in a complex; and the sum of the maximum downstream distance and the maximum upstream distance if d and t are not in a complex is otherwise set at 0.

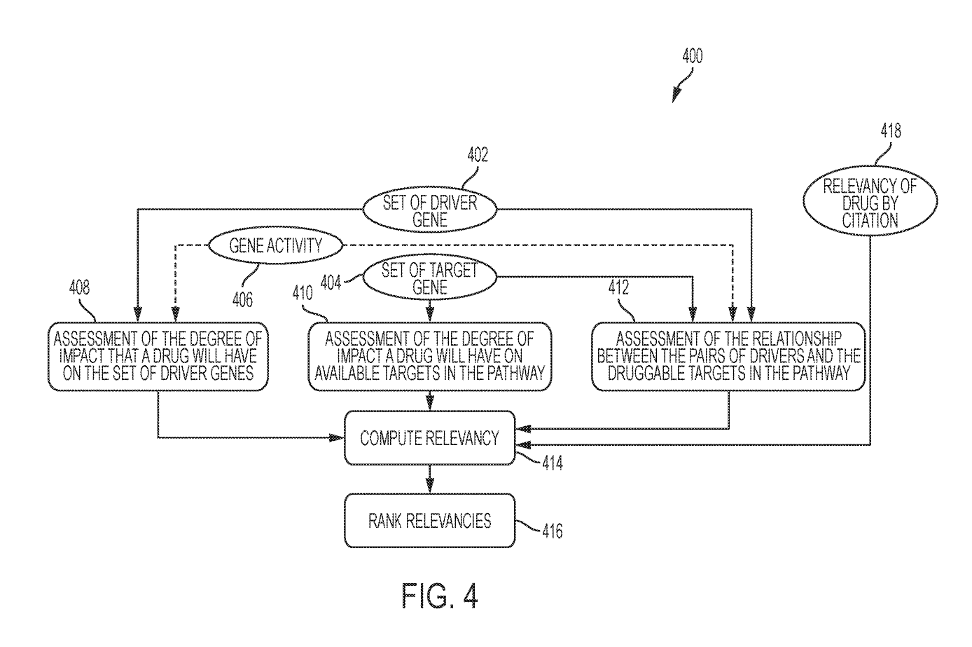

FIG. 4 depicts a flow diagram illustrating a methodology 400 of drug assessment system 200 in accordance with one or more embodiments. As shown, block 408 receives a set of DG inputs from block 402 and (optionally) gene activity inputs from block 406. Block 408 develops an assessment of the degree of impact that a drug will have on the set of DGs of the disease of interest. An exemplary implementation of block 408 is Equation (1) and Equation (2) shown in FIG. 3A. Block 410 a set of TGs from block 404. Block 410 develops an assessment of the degree of impact a drug will have on available targets in the pathway. An exemplary implementation of block 410 is Equations (1) and (3) shown in FIG. 3A. Block 412 receives (optionally) gene input activity from block 406, a set of TGs from block 404 and a set of DGs inputs from block 402. An exemplary implementation of block 412 is the C-term calculation shown in FIG. 3C. Block 412 develops an assessment of the relationship between the pairs of DGs and the druggable targets within the pathway. Block 418 develops a relevancy of the drug by citation. An exemplary implementation of block 418 is Equation (2) shown in FIG. 3A. Block 414 takes the outputs of the assessments made by blocks 408, 410 and 412 and determines a relevancy of the current pathway of interest. Block 416 assembles and ranks the relevancies serially determined by block 414. The rankings identified by blocks 414 and 416 allow the simplification process performed by block 418 to be focused on pathways having the highest relevancy. In addition to the drug score shown at Equation (1) in FIG. 3A, drug relevancy assessment made according to the present disclosure may be quantified by other criteria of the ranked drugs.

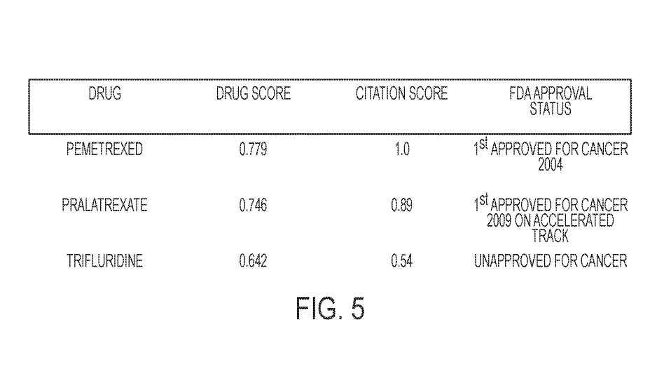

FIG. 5 depicts an exemplary table illustrating how the relevancy rankings identified by blocks 414 and 416 may be organized and displayed. In the example shown in FIG. 5, a breast cancer patient sample, the gene TYMS (Uniprot ID# P04818) is identified as a putative driver gene of this patient's cancer. Three putatively effective drugs targeting TYMS are summarized in the table shown in FIG. 5. The scored drugs, though molecularly similar in their direct targeting of the same gene, are able to be differentiated by their relevance to cancer treatment through the literature citation score. Here Pemetrexed has a higher citation score that may be reflective of its longer approved use in cancer. Pralatrexate has a citation score that is slightly lower, which is likely due to the five year difference in approval time and its accelerated approval track. In other words, Pralatrexate spent less time under review than is typical for most FDA approved therapies. The small margin between Pemetrexed and Pralatrexate is also a reflection of the trimmed maximum value of possible for the citation score, even if many more citations exist. Trifluridine has been studied in cancer but is unapproved and is not as well studied. By utilizing the citation score into the drug assessment score, the present disclosure provides systems and methodologies that allow a user to better rank and identify subtle differences between drug recommendations that may seem, without benefit of the disclosed drug ranking methodology, to be substantially the same.

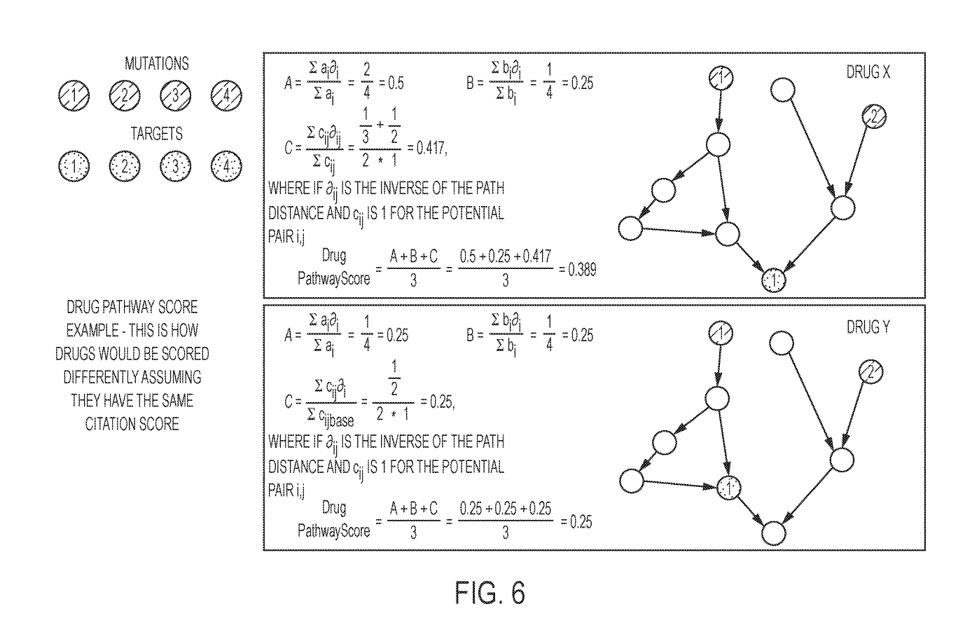

FIG. 6 depicts diagrams illustrating two examples of how a drug assessment methodology (e.g., methodology 400 shown in FIG. 4) of drug assessment system 200 (shown in FIG. 2) may be implemented in accordance with one or more embodiments. The drug pathway score examples shown in FIG. 6 show how drugs might be scored differently assuming the drugs have the same citation scores. For drug X, “i” is equal to, sequentially, one (1) to four (4), the third and fourth GMs are not in the pathway that leads to a disease. The second, third and fourth druggable target genes are not upstream or downstream of any druggable gene in the pathway, and “a” is one (1) in all cases. Also, “b” is one (1) in all cases, ∂ᵢⱼ is the inverse of the path distance and cᵢⱼ is one (1) for the potential pair “i, j.” As shown in FIG. 6, the drug relevance score calculated for drug X is 0.389.

For drug Y, “i” is equal to, sequentially, one (1) to four (4), the second and fourth GMs are not in the pathway that leads to a disease. The second and fourth druggable target genes are not upstream or downstream of any druggable gene in the pathway, “a” is one (1) in all cases, “b” is one (1) in all cases, ∂ᵢⱼ is the inverse of the path distance, and cᵢⱼ is one (1) for the potential pair “i,j.” Drug Y is slightly different from drug X in that the first GM has an addition and more direct pathway to the first druggable gene. As shown in FIG. 6, the relevance score calculated for drug Y is 0.25, which is lower than the 0.389 relevance score calculated for drug X. Accordingly, drug Y is slightly less relevant for the disease of interest than drug X.

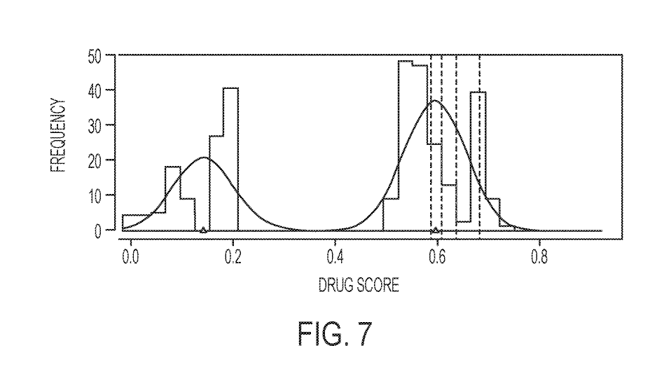

FIG. 7 depicts a histogram of drug scores with fitted binomial distribution for a neuroblastoma patient sample in accordance with one or more embodiments. One or more embodiments of the present disclosure may be used in the context of evaluating drugs as potential treatments for cancer patients given their genomics and transcriptomic (gene expression) profile. Sample files were analyzed and drugs scored using the disclosed systems and methodologies (e.g., system 200, methodology 400, Equations (1) through (8)). The X-axis indicates the drug relevancy/effectiveness scores. The hashed lines indicate the drug relevancy/effectiveness scores for drugs that were expected to be effective for this sample and represent the gold standard. In one case of neuroblastoma, a form of brain cancer, 187 drugs are found that may be effective. The disclosed systems and methodologies were was used to score each of these drugs, which were then sorted and filtered for drugs that are the most effective for the patient. In this analysis represented in FIG. 7, as well as others (data not shown), it was observed that the distribution of scores tends to be multi-modal.

In the example analysis shown in FIG. 7, the most effective drugs were found to be entirely contained among the top scoring drugs. Accordingly, the disclosed scoring systems and methodologies correctly captured and scored highly drugs known to be most effective. In fact, all top scoring drugs, i.e., drugs found in the highest scoring mode, are common cancer treatment drugs. In a typical application of the disclosed scoring systems and methodologies, the user would present the scored drugs, and all supporting evidence, to a medical review board that would decide upon the ultimate treatment. Such feedback may be used in the disclosed drug scoring systems and methodologies to learn more about drugs that were the most applicable to the patient, and use that information to improve the disclosed drug scoring systems and methodologies to be even more effective in capturing highly effective drugs for the next patient with similar genomic and transcriptomic profiles. Furthermore, such feedback would aid the disclosed drug scoring systems and methodologies learn whether lower scoring drugs can be dismissed as false positives. Accordingly, thresholds may be developed for the automatic detection of thresholds by which to filter the set of potential drugs to a more manageable size for the physician and review boards. For example low-scoring drugs could be evaluated as being below a certain value that is determined empirically, e.g. fitting multiple distributions and finding the point of intersection as shown in FIG. 7. In the above example, if the threshold were chosen as the point of intersection of both distributions, i.e. 0.36, the number of reported drugs can be reduced from 187 to 134. The determination of the final threshold is performed using gold standard samples and the consultation of experts to ensure low false positive and false negative rates.

Thus it can be seen from the foregoing detailed description that the present disclosure provides a number of technical benefits, including the generation of a quantitative metric to rank a drug based at least in part on the likelihood that the drug is relevant to the treatment of a selected disease in a specific patient sample. The relevancy of a given drug to a given disease depends on possibly hundreds of DGs, thousands of different DTs across thousands of drugs, and the gene activity level of approximately 20,000 genes. Because biological pathways are the basic mechanism for understanding DG/DT relationships, a drug's relevancy may be influenced by all possible paths within a dense network from DGs to DTs, as well as how these possible paths are altered by changes in gene activity of any member of the path.

The present disclosure provides clinicians with the ability to quickly sort and filter the hundreds or thousands of potential drugs available to treat cancer and other diseases in a specific patient. Using the drug assessment/effectiveness systems and methodologies of the present disclosure, a clinician can create a highly personalized disease treatment, which may in some cases include administering drugs that are not be generally known to be part of the diagnostic and treatment process for a certain type of patient, illness or clinical circumstance. The computational approach of the disclosed systems and methodologies can account for multiple factors and quickly score a drug's relative importance with respect to other available drugs. The disclosed drug assessment systems and methodologies measure the biological relationships between DT's and DG's, and then combine this measure with a score that describes a drug's published relevancy to the patient's disease. These features enable the disclosed systems and methodologies to capture drugs having mechanisms with respect to a DG that are less well characterized but nonetheless may in fact be important to the treatment of the patient's disease.

Accordingly, the operation of a computer system implementing one or more of the disclosed embodiments can be improved.

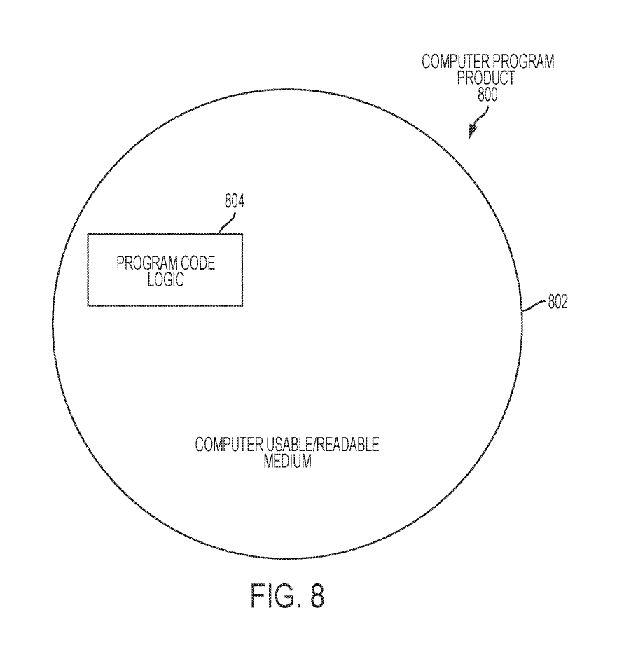

Referring now to FIG. 8, a computer program product 800 in accordance with an embodiment that includes a computer readable storage medium 802 and program instructions 804 is generally shown.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

It will be understood that those skilled in the art, both now and in the future, may make various improvements and enhancements which fall within the scope of the claims which follow.

1. A computer implemented method of developing a personalized drug regimen for treatment of a disease state of a patient, the method comprising:
generating a genomic profile of the patient, wherein the genomic profile comprises driver genes (DGs) of the disease state of the patient;
assessing, by a processor system, an impact of a drug on the DGs of the disease state of the patient;
wherein assessing the impact of the drug on the DGs of the disease state of the patient comprises determining an A-term according to the equation:
A-term=(Σaᵢ∂ᵢ)/(Σaᵢ), wherein aᵢ weights the presence or absence of gene mutations (GMs) of the DGs, the subscript i is a unique number identifying each of the GMs, and ∂ᵢ comprises a binary term that is 1 if the GM is a targetable DG and zero (0) if the GM is not a targetable DG;
assessing, by the processor system, an impact of the drug on the DTs of the drug, wherein the impact of the drug on the DTs includes behavior of the DTs in the patient, wherein the behavior of the DTs in the patient includes a level of activity of the DTs or the presence or absence of mutations of the DTs in one of a plurality of biological pathways of interest;
wherein assessing the impact of the drug on DTs of the drug comprises determining a B-term according to the equation:
B-term=(Σbᵢ∂ᵢ)/(Σbᵢ), wherein bᵢ weights various consideration associated with targeting the DGs, the subscript i is a unique number identifying each of the DGs, and ∂ᵢ comprises a binary term that is 1 if the DG is in one of a plurality of pathways of interest and zero (0) if the DG is not in one of the plurality of pathways of interest;
assessing, by the processor system, the relationship between the DGs and DTs that are in one of the plurality of biological pathways of the disease state of the patient;
wherein assessing the relationship between the DGs and the DTs that are in one of the plurality of biological pathways of the disease state of the patient comprises determining a C-term according to the equation:
C-term=(Σcᵢⱼ∂ᵢⱼ)/(Σcᵢⱼ), wherein the subscript i is a unique number identifying each of the DGs, the subscript is a unique number identifying each of the DTs, cᵢⱼ is a number that weights the relationship between individual DGs and individual DTs, and ∂ᵢⱼ comprises a binary term that is 1 if individual DGs are downstream of one of the GMs;
performing, by the processor system, a citation analysis of the drug, wherein the citation analysis comprises an identification of literature describing that a drug that has not been approved for treatment of the disease state of the patient has been demonstrated to have efficacy for the disease state of the patient;
combining:
the impact of the drug on the DGs;
the impact of the drug on the DTs;
the relationship between the DGs and DTs that are in the one of the biological pathways; and
the citation analysis;
wherein the combining results in an assessment of the relevancy of the drug to the disease state of the patient; and
based at least in part on the assessment of the relevancy of the drug, including the drug in the personalized drug regimen for treatment of the disease state of the patient.

2. (canceled)

3. The computer implemented method of claim 1, wherein the citation analysis comprises a score based at least in part on the literature that identifies an efficacy of the drug for the disease state of the patient.

4. The computer implemented method of claim 1, wherein the impact of the drug on the DGs comprises weighted values of the DGs.

5. The computer implemented method of claim 1, wherein the impact of the drug on the DTs comprises weighted values of the DTs.

6. The computer implemented method of claim 1, wherein an expression level of each DG and DT in the one of the biological pathways defines a height dimension of a topology that defines part of the relationship between the DGs and DTs that are in the one of the biological pathways.

7. The computer implemented method of claim 1 further comprising:
iterating the method of claim 1 multiple times for multiple drugs to generate multiple assessments of the relevancy of the multiple drugs to the disease state of the patient; and
ranking, by the processor system, the multiple assessments of the relevancy of the multiple drugs to the disease state of the patient.

8. A computer system for developing a personalized drug treatment regimen for treatment of a disease state of a patient, the system comprising:
a memory; and
a processor system communicatively coupled to the memory;
the processor system being configured to perform a method comprising:
generating a genomic profile of the patient, wherein the genomic profile comprises driver genes (DGs) of the disease state of the patient;
assessing an impact of a drug on the DGs of the disease state of the patient;
wherein assessing the impact of the drug on the DGs of the disease state of the patient comprises determining an A-term according to the equation:
A-term=(Σaⱼ∂ⱼ)/(Σaⱼ), Wherein aⱼ weights the presence or absence of gene mutations (GMs) of the DGs, the subscript i is a unique number identifying each of the GMs, and ∂ⱼ comprises a binary term that is 1 if the GM is a targetable DG and zero (0) if the GM is not a targetable DG;
assessing an impact of the drug on druggable target genes (DTs) of the drug, wherein the impact of the drug on the DTs includes behavior of the DTs in the patient, wherein the behavior of the DTs in the patient includes a level of activity of the DTs or the presence or absence of mutations of the DTs in one of a plurality of biological pathways of interest;
wherein assessing the impact of the drug on DTs of the drug comprises determining a B-term according to the equation:
B-term=(Σbᵢ∂ᵢ)/(Σbᵢ), wherein bᵢ weights various consideration associated with targeting the DGs, the subscript i is a unique number identifying each of the DGs, and ∂ᵢ comprises a binary term that is 1 if the DG is in one of a plurality of pathways of interest and zero (0) if the DG is not in one of the plurality of pathways of interest;
assessing the relationship between the DGs and DTs that are in one of the plurality of biological pathways of the disease state of the patient;
wherein assessing the relationship between the DGs and the DTs that are in one of the plurality of biological pathways of the disease state of the patient comprises determining a C-term according to the equation:
C-term=(Σcᵢⱼ∂ᵢⱼ)/(Σcᵢⱼ), wherein the subscript i is a unique number identifying each of the DGs, the subscript j is a unique number identifying each of the DTs, cᵢⱼ is a number that weights the relationship between individual DGs and individual DTs, and ∂ᵢⱼ comprises a binary term that is 1 if individual DGs are downstream of one of the GMs;
performing a citation analysis of the drug, wherein the citation analysis comprises an identification of literature describing that a drug that has not been approved for treatment of the disease state of the patient has been demonstrated to have efficacy for the disease state of the patient;
combining:
the impact of the drug on the DGs;
the impact of the drug on the DTs;
the relationship between the DGs and DTs that are in the one of the biological pathways; and
the citation analysis;
wherein the combining results in an assessment of the relevancy of the drug to the disease state of the patient; and
based at least in part on the assessment of the relevancy of the drug, including the drug in the personalized drug regimen for treatment of the disease state of the patient.

9. (canceled)

10. The computer system of claim 8, wherein the citation analysis comprises a score based at least in part on the literature that identifies an efficacy of the drug for the disease state of the patient.

11. The computer system of claim 8, wherein the impact of the drug on the DGs comprises weighted values of the DGs.

12. The computer system of claim 8, wherein the impact of the drug on the DTs comprises weighted values of the DTs.

13. The computer system of claim 8, wherein an expression level of each DG and DT in the one of the biological pathways defines a height dimension of a topology that defines part of the relationship between the DGs and DTs that are in the one of the biological pathways.

14. The computer system of claim 8, wherein the method performed by the processor system further comprises:
iterating the system of claim 8 multiple times for multiple drugs to generate multiple assessments of the relevancy of the multiple drugs to the disease state of the patient; and
ranking the multiple assessments of the relevancy of the multiple drugs to the disease state of the patient.

15. A computer program product for developing a personalized drug regimen for treatment of a disease state of a patient, the computer program product comprising:
a computer readable storage medium having program instructions embodied therewith, wherein the computer readable storage medium is not a transitory signal per se, the program instructions readable by a processor system to cause the processor system to perform a method comprising:
generating a genomic profile of the patient, wherein the genomic profile comprises driver genes (DGs) of the disease state of the patient;
assessing an impact of a drug on the DGs of the disease state of the patient;
wherein assessing the impact of the drug on the DGs of the disease state of the patient comprises determining an A-term according to the equation:
A-term=(Σaᵢ∂ᵢ)/(Σaᵢ), wherein aᵢ weights the presence or absence of gene mutations (GMs) of the DGs, the subscript i is a unique number identifying each of the GMs, and ∂ᵢ comprises a binary term that is 1 if the GM is a targetable DG and zero (0) if the GM is not a targetable DG;
assessing an impact of the drug on druggable target genes (DTs) of the drug, wherein the impact of the drug on the DTs includes behavior of the DTs in the patient, wherein the behavior of the DTs in the patient includes a level of activity of the DTs or the presence or absence of mutations of the DTs in one of a plurality of biological pathways of interest;
wherein assessing the impact of the drug on DTs of the drug comprises determining a B-term according to the equation:
B-term=(Σbᵢ∂ᵢ)/(Σbᵢ), wherein bᵢ weights various consideration associated with targeting the DGs, the subscript i is a unique number identifying each of the DGs, and ∂ᵢ comprises a binary term that is 1 if the DG is in one of a plurality of pathways of interest and zero (0) if the DG is not in one of the plurality of pathways of interest;
assessing the relationship between the DGs and DTs that are in one of the plurality of biological pathways of the disease state of the patient;
wherein assessing the relationship between the DGs and the DTs that are in one of the plurality of biological pathways of the disease state of the patient comprises determining a C-term according to the equation:
C-term (Σcᵢⱼ∂ᵢⱼ)/(Σcᵢⱼ), wherein the subscript i is a unique number identifying each of the DGs, the subscript j is a unique number identifying each of the DTs, cᵢⱼ is a number that weights the relationship between individual DGs and individual DTs, and ∂ᵢⱼ comprises a binary term that is 1 if individual DGs are downstream of one of the GMs;
performing a citation analysis of the drug, wherein the citation analysis comprises an identification of literature describing that a drug that has not been approved for treatment of the disease state of the patient has been demonstrated to have efficacy for the disease state of the patient;
combining:
the impact of the drug on the DGs;
the impact of the drug on the DTs;
the relationship between the DGs and DTs that are in the one of the biological pathways; and
the citation analysis;
wherein the combining results in an assessment of the relevancy of the drug to the disease state of the patient; and
based at least in part on the assessment of the relevancy of the drug, including the drug in the personalized drug regimen for treatment of the disease state of the patient.

16. The computer program product of claim 15, wherein:
the citation analysis comprises a score based at least in part on the literature that identifies an efficacy of the drug for the disease state of the patient.

17. The computer program product of claim 15, wherein the impact of the drug on the DGs comprises weighted values of the DGs.

18. The computer program product of claim 15, wherein the impact of the drug on the DTs comprises weighted values of the DTs.

19. The computer program product of claim 15, wherein an expression level of each DG and DT in the one of the biological pathways defines a height dimension of a topology that defines part of the relationship between the DGs and DTs that are in the one of the biological pathways.

20. The computer program product of claim 15 further comprising:
iterating the computer program product of claim 15 multiple times for multiple drugs to generate multiple assessments of the relevancy of the multiple drugs to the disease state of the patient; and
ranking the multiple assessments of the relevancy of the multiple drugs to the disease state of the patient.
